(19) United States
(12) Patent Application Publication
(10) Pub. No.: US 2012/0031236 A1
(43) Pub. Date: Feb. 9, 2012

(54) METHOD AND INSTALLATION FOR PRODUCING DIRECT REDUCED IRON

(75) Inventors: Jean-Luc Roth, Thionville (FR); David Rodriguez, Guenange (FR)

(73) Assignee: PAUL WURTH S.A., Luxembourg (LU)

(21) Appl. No.: 13/262,796

(22) PCT Filed: Apr. 6, 2010
(86) PCT No.: PCT/EP2010/054491

§ 371 Date: Oct. 3, 2011

(30) Foreign Application Priority Data
Apr. 3, 2009 (LU) 91 547

(51) Int. Cl. C21B 13/02; F27B 1/10; F27D 17/00

(52) U.S. Cl. 75/488; 75/392; 266/156

(57) ABSTRACT

“A method for producing direct reduced iron in a vertical reactor having an upper reducing zone and a lower cooling zone, the method including:
feeding iron oxide feed material to an upper portion of the vertical reactor, the iron oxide feed material forming a burden flowing by gravity to a material outlet portion in a lower portion of the vertical reactor; feeding hot reducing gas to a lower portion of the reducing zone of the vertical reactor, the hot reducing gas flowing in a counter flow to the burden towards a gas outlet port in the upper portion of the vertical reactor; recovering direct reduced iron at the lower portion of the vertical reactor; recovering top gas at the upper portion of the vertical reactor; submitting at least a portion of the recovered top gas to a recycling process; and feeding the recycled top gas back into the vertical reactor, where the recycling process includes heating the recovered top gas in a preheating unit before feeding it to a reformer unit; feeding volatile carbon containing material to the reformer unit and allowing the volatile carbon containing material to devolatise and to react with the recovered top gas; feeding desulfurizing agent into the recovered top gas in or upstream of the reformer unit; heating the reformer unit; and feeding the reformed top gas recovered from the reformer unit through a particle separation device for removal of sulfur containing material.”

### TECHNICAL FIELD

The present invention generally relates to a method for producing direct reduced iron (DRI), in particular in a vertical reactor. The present invention also relates to an installation for producing direct reduced iron.

### BACKGROUND

Direct reduced iron (DRI), also called sponge iron, is produced by direct reduction of iron ore (in the form of lumps, pellets or fines) by a reducing gas produced from natural gas or coal. The direct reduction of the iron ore generally takes place in a vertical reactor wherein a burden of iron ore flows downwards, while the reducing gas flows upwards and reacts with the burden.

Most installations use natural gas as its fuel source for producing DRI. The reducing gas necessary for stripping away the chemically bound oxygen from the iron oxide is generated in a complex process gas system, wherein CO₂ and H₂O is reformed by natural gas into CO and H₂. It should be noted that the installation for producing the required reducing gas is complex and hence expensive. A further disadvantage of this installation is that in some of the largest steel producing countries the natural gas costs are relatively high.

As an alternative, installations that use coal as its fuel source for producing DRI have been proposed. Such installations, as e.g. described in U.S. Pat. No. 4,173,465, propose to use a gasification plant to produce fresh reducing gas. Some of the reducing gas is obtained by recycling used reducing gas recovered from the vertical reactor. The used reducing gas must however first have most of its CO₂ removed to obtain a high enough gas quality for reuse as reducing gas. In order to achieve this, a CO₂ removal unit, generally in the form of a Pressure Swing Adsorption (PSA) or Vacuum Pressure Swing Adsorption (VPSA) is used. PSA/VPSA installations, as e.g. shown in U.S. Pat. No. 6,478,841, produce a first stream of gas which is rich in CO and H₂ and a second stream of gas rich in CO₂ and H₂O. The first stream of gas may be used as reduction gas. The second stream of gas is removed from the installation and, after extraction of the remaining calorific value, disposed of. This disposal controversially consists in pumping the CO₂ rich gas into pockets underground for storage. Furthermore, although PSA/VPSA installations allow a considerable reduction of CO₂ content in the top gas from about 35% to about 5%, they are very expensive to acquire, to maintain and to operate and they need a lot of space. The first stream of gas, i.e. the CO₂ depleted gas, from the PSA/VPSA installation is then mixed with the fresh reducing gas produced by the gasification plant. At this point, the resulting reducing gas is near ambient temperature and must be heated prior to injecting into the vertical reactor.

Other installations propose to use a melter-gasifier to produce most of the reducing gas. In such a melter-gasifier, top gas is recovered from the reduction shaft of the melter-gasifier and fed to the PSA/VPSA installation, which also receives top gas from the vertical reactor. The gas from the PSA/VPSA installation may, after passing through a heating stage, be used as reducing gas in the vertical reactor.

### BRIEF SUMMARY OF THE INVENTION

The invention provides an improved method for producing direct reduced iron (DRI). The invention further provides an improved installation for producing direct reduced iron.

The present invention proposes a method for producing direct reduced iron in a vertical reactor having an upper reducing zone and a lower cooling zone, the method comprising the steps of:

feeding iron oxide feed material to an upper portion of the vertical reactor, the iron oxide feed material forming a burden flowing by gravity to a material outlet portion in a lower portion of the vertical reactor; feeding hot reducing gas to a lower portion of the reducing zone of the vertical reactor, the hot reducing gas flowing in a counter flow to the burden towards a gas outlet port in the upper portion of the vertical reactor; recovering direct reduced iron at the lower portion of the vertical reactor; recovering top gas at the upper portion of the vertical reactor; submitting at least a portion of the recovered top gas to a recycling process; and feeding the recycled top gas back into the vertical reactor.

According to an important aspect of the invention, the recycling process comprises heating the recovered top gas in a heating unit and feeding the recovered top gas to a reformer unit; feeding volatile carbon containing material to the reformer unit and allowing the volatile carbon containing material to devolatise and to react with the recovered top gas; feeding desulfurizing agent into the recovered top gas in or upstream of the reformer unit; heating of the recovered top gas in the reformer unit; and feeding the reformed top gas recovered from the reformer unit through a particle separation device for removal of sulfur containing material and, preferably also residue (gangue or ash+some fixed carbon) left from the coal.

The recovered top gas is heated in the heating unit arranged upstream of the reformer unit. Such a heating unit is preferably a hot stove, such as a Cowper, or a pebble heater or any high temperature heat exchanger. The mixing of the recovered top gas with volatile carbon containing material allows reducing the CO₂ content in the top gas and also allows increasing the gas volume. Indeed, when the volatile carbon containing material enters the reformer unit into which the recovered top gas is fed, the volatile carbon containing material is subjected to an at least partial devolatisation due to the high temperature reigning in the reformer unit. This leads to part of the volatile content of the volatile carbon containing material being liberated in the form of additional gas, which in turn leads to an increase in gas volume. At the same time, the carbon content of the volatile carbon containing material reacts with the carbon dioxide in the top gas and converts the carbon dioxide to carbon monoxide according to the reaction CO₂+C→2 CO. A considerable amount of carbon dioxide can, through this process, be converted into carbon monoxide.

A CO₂ reduction, similar to that achieved by PSA/VPSA installations, can be achieved, i.e. the CO₂ content can be reduced from 35-40% to 4-8%. However, the installation needed to carry out the present method is considerably cheaper than a PSA/VPSA installation; it is not only cheaper in the acquisition of the installation, but also in its maintenance and operation. It should also be noted that the present method does not necessitate the cooling of the top gas for CO₂ reduction. As a consequence, the top gas does not need to be subsequently heated, i.e. after passing through the reforming unit, for injection into the vertical reactor. Although the top gas is according to the present method heated before CO₂ reduction, the overall heating required is reduced in comparison to PSA/VPSA installations.

The mixing of the recovered top gas with desulfurizing agent allows reducing the sulfur content in the top gas. Indeed, when the desulfurizing agent interacts with the top gas, the sulfur combines to a sulfur receptor and forms a particulate material that can easily be removed from the top gas by means of a particle separation device, e.g. a cyclone. Due to the desulfurizing agent and the removal of the sulfur from the top gas, the level of sulfur in the top gas, fed as reducing gas into the vertical reactor, can be kept below the maximum that can be tolerated for the direct reduction process.

It should also be noted that, according to the present method, the reforming and the desulfurizing of the top gas is carried out in series as opposed to some prior art methods wherein these steps are carried out in parallel.

In the context of the present invention, volatile carbon containing material is understood to have a calorific power of at least 15 MJ/kg and to comprise volatile coal, volatile plastic material or a mixture thereof. Other volatile carbon containing material having a calorific power of at least 15 MJ/kg may however also be envisaged.

Preferably, volatile coal is understood to be a coal comprises at least 25% of volatile materials. Advantageously, the volatile coal is highly volatile coal comprising at least 30% of volatile materials. The volatile coal injected into the reformer unit may e.g. comprise about 35% of volatile materials. It should be noted that the percentage of volatile materials is preferably as high as possible and that the above percentage indications are in no way intended to indicate an upper limit for the volatile material content.

Preferably, volatile plastic material is understood to be a plastic material comprises at least 50% of volatile materials. The plastic material may e.g. comprise automobile shredder residue. It should be noted that the percentage of volatile materials is preferably as high as possible and that the above percentage indications are in no way intended to indicate an upper limit for the volatile material content.

Advantageously, the volatile carbon containing material is ground and/or dried before being injected into the reformer unit in order to facilitate the devolatisation of the volatile carbon containing material in the reformer unit.

The reformer unit is preferably heated by means of at least one plasma torch and/or by means of oxygen injection into the stream of recovered top gas. Other means for heating the reformer unit may be envisaged; they should however preferably avoid feeding nitrogen to the system.

The recovered top gas is advantageously heated to a temperature of at least 900° C., preferably to a temperature between 1100 and 1300° C., preferably about 1250° C., before introduction into the reformer unit.

The present invention provides a further embodiment for heating the top gas upstream of the heating unit, wherein a portion of the recovered top gas is fed through the cooling zone of the vertical reactor. A portion of the recovered top gas may be injected as cooling gas into a lower portion of the cooling zone and recovered in an upper portion of the cooling zone, the injected top gas flowing from the lower portion to the upper portion in a counter flow to the burden. Due to the interaction between the hot burden and the cold top gas, heat is transferred from the burden to the top gas, leading to a cooling of the burden while heating up the top gas. The top gas heated in the cooling zone is retrieved from the vertical reactor at the upper portion of the cooling zone and fed as pre-heated top gas to the heating unit.

The desulfurizing agent is preferably calcium containing desulfurizing agent, such as e.g. calcium carbonate or calcium oxide. Calcium carbonate may be fed into the recovered top gas upstream of the reformer unit. Due to the high temperatures of the top gas, the calcium carbonate transforms into calcium oxide, which in turn reacts with the top gas to bond with the sulfur. Alternatively, calcium oxide may be directly fed into the recovered top gas directly in the reformer unit.

In order to facilitate the removal of the sulfur containing material in the cyclone, the desulfurizing agent preferably has grain size of at least 80 microns, more preferably at least 100 microns.

The present invention also concerns an installation for producing direct reduced iron comprising a vertical reactor having an upper reducing zone and a lower cooling zone; and a gas recycling installation for recovering top gas from the vertical reactor, submitting at least a portion of the top gas to a recycling process and feeding the recycled top gas back into the vertical reactor. According to an important aspect of the invention, the gas recycling installation comprises a heating unit and a reformer unit; and the gas recycling installation is configured to carry out the method as described above.

### BRIEF DESCRIPTION OF THE DRAWINGS

Preferred embodiments of the invention will now be described, by way of example, with reference to the accompanying drawing, in which:

FIG. 1 is a schematic view of an installation for producing direct reduced iron according to the method of the present invention.

### DETAILED DESCRIPTION

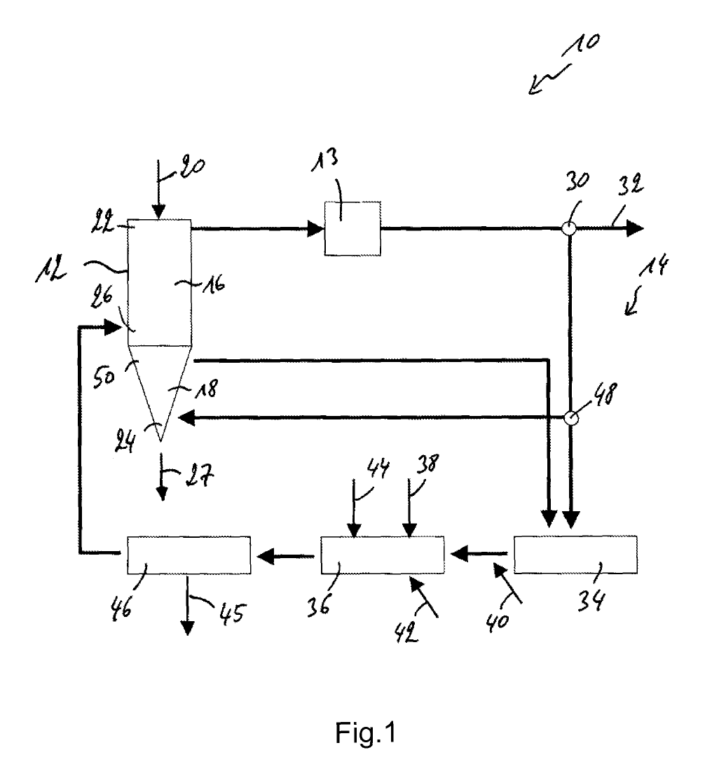

FIG. 1 generally shows an installation 10 for producing direct reduced iron comprising a vertical reactor 12 with an off-gas cleaning system 13 and a reducing gas recycling installation 14. The vertical reactor 12 has an upper, reducing zone 16 and a lower, cooling zone 18. A charge of iron oxide feed material 20 is fed to an upper portion 22 of the reducing zone 16 of the vertical reactor 12 and forms a burden flowing by gravity towards a lower portion 24 the cooling zone 18 of the vertical reactor 12. At a lower portion 26 of the reducing zone 16, a reducing gas is fed into the vertical reactor 12. The reducing gas travels towards the upper portion 22 of the reducing zone 16 in a counter flow to the burden. Due to the interaction between the burden and the reducing gas, the iron oxide feed material 20 is transformed into direct reduced iron 27, which is extracted from the vertical reactor 12 at the lower portion 24 the cooling zone 18. The operation of such a vertical reactor 12 for producing direct reduced iron is well known and will not be further described herein.

The installation 10 further comprises a gas recycling installation 14 with means for recovering spent reducing gas as top gas from the vertical reactor 12, means for treating the recovered top gas and means for injecting the treated top gas as reducing gas back into the vertical reactor 12. The gas recycling installation 14 is more closely described herebelow.

The spent reducing gas is recovered from the upper portion 22 of the vertical reactor 12 and first fed through the off-gas cleaning system 13, wherein the amount of dust or foreign particles is reduced.

After passing through the off-gas cleaning system 13, the top gas is fed to a first distribution valve 30, which allows only a predetermined amount of gas to remain in the gas recycling installation 14 to be injected back into the vertical reactor 12. Excess top gas 32 is discharged away from the installation 10 and may be used in other applications. In particular, the excess top gas 32 may be used for heating other installations.

From the first distribution valve 30, a predetermined amount of top gas is sent through a heating unit represented therein by Cowper heaters 34, wherein the top gas is heated to a temperature in the range of 1100 to 1300° C., preferably 1250° C.

The heated top gas is then fed to a reformer unit 36 where in the top gas is treated. Apart from the heated top gas, highly volatile carbon containing material 38 is injected into the reformer unit 36. The top gas generally comprises between 30 and 40% of carbon dioxide CO₂. Due to the high temperature of the top gas, the highly volatile carbon containing material 38 releases its volatile content in the form of gas, leaving behind the carbon content, which interacts with the carbon dioxide of the top gas, mainly according to the formula CO₂+C→2CO. A considerable amount of carbon dioxide can, through this process, be converted into carbon monoxide. Applicant has calculated that this process allows a CO₂ reduction from roughly 30% to about 15% or less.

Furthermore, a desulfurizing agent 40, 42, preferably a calcium containing desulfurizing agent, is fed to the top gas either in or upstream of the reformer unit 36. According to a preferred embodiment, calcium carbonate (CaCO₃) containing material 40 is injected into the heated top gas between the Cowper heaters 34 and the reformer unit 36. Due to the high temperature of the top gas, the calcium carbonate containing material 40 transforms according to the formula CaCO₃→CaO+CO₂. According to another embodiment, calcium oxyde (CaO) containing material 42 is injected into the heated top gas directly in the reformer unit 36. In the reformer unit 36, the calcium oxide 42 reacts with the sulfur to form calcium sulfide (CaS) according to the formula CaO+S→CaS+O.

The reformer unit 36 is further heated so as to facilitate the devolatisation of the volatile carbon containing material and the conversion of carbon dioxide into carbon monoxide. This may be achieved by feeding oxygen 44 into the reformer unit 36. Alternatively, one or more plasma torches may be provided for furnishing this additional heat. Other means for furnishing this additional heat may also be envisaged; they should however avoid feeding nitrogen to the system.

The formation of calcium sulfide allows for a removal of the sulfur 45 contained in the top gas. Indeed, feeding sulfur back into the vertical reactor 12 should be avoided. The top gas exiting the reformer unit 36 is therefore fed through a particle separation device 46, e.g. a cyclone. In order to facilitate the removal of sulfur containing material and coal residue, the grain size of the desulfurizing agent is preferably chosen to be at least 100 micron.

The above process not only leads to an increase in carbon monoxide (CO) in the top gas but also to an increase in hydrogen (H₂). Due to the gas volume increase in the reformer unit 36, the first distribution valve 34 is controlled such that amount of reformed top gas exiting the reformer unit 36 corresponds to the desired amount of gas to be blown back into the vertical reactor 12.

A second distribution valve 48 may be provided between the first distribution valve 30 and the Cowper heaters 34 for feeding part of the recovered top gas through the cooling zone 18 of the vertical reactor 12. The recovered top gas is fed as cooling gas into the lower portion 24 of the cooling zone 18 and travels towards an upper portion 50 of the cooling zone 18 in a counter flow to the burden. Due to the interaction between the hot burden and the cold top gas, heat is transferred from the burden to the top gas, leading to a cooling of the burden while heating up the top gas. The top gas heated in the cooling zone 18 is retrieved from the vertical reactor 12 at the upper portion 50 of the cooling zone 18 and fed as pre-heated top gas to the Cowper heaters 34.

1. A method for producing direct reduced iron in a vertical reactor having an upper reducing zone and a lower cooling zone, said method comprising the steps of:
feeding iron oxide feed material to an upper portion of said vertical reactor, said iron oxide feed material forming a burden flowing by gravity to a material outlet portion in a lower portion of said vertical reactor;
feeding hot reducing gas to a lower portion of said reducing zone of said vertical reactor, said hot reducing gas flowing in a counter flow to said burden towards a gas outlet port in said upper portion of said vertical reactor;
recovering direct reduced iron at said lower portion of said vertical reactor;
recovering top gas at said upper portion of said vertical reactor;
submitting at least a portion of said recovered top gas to a recycling process; and
feeding said recycled top gas back into said vertical reactor
characterized in that said recycling process comprises:
heating said recovered top gas in a heating unit before feeding said recovered top gas to a reformer unit;
feeding volatile carbon containing material to said reformer unit and allowing said volatile carbon containing material to devolatise and to react with said recovered top gas;
feeding desulfurizing agent into said recovered top gas in or upstream of said reformer unit;
heating said reformer unit; and
feeding the reformed top gas recovered from said reformer unit through a cyclone for removal of sulfur containing material.

2. The method according to claim 1, wherein said volatile carbon containing material comprises volatile coal with at least 25% of volatile materials, preferably with at least 30% of volatile materials, more preferably with about 35% of volatile materials.

3. The method according to claim 1 or 2, wherein said volatile carbon containing material comprises volatile plastic material with at least 50% of volatile materials.

4. The method according to any of claims 1 to 3, wherein said volatile carbon containing material has a calorific power of at least 15 MJ/kg.

5. The method according to any of claims 1 to 4, wherein said volatile carbon containing material is ground and/or dried before being injected into said reformer unit.

6. The method according to any of claims 1 to 5, wherein said reformer unit is heated by means of at least one plasma torch and/or by means of oxygen injection into the stream of recovered top gas.

7. The method according to any of claims 1 to 6, wherein said heating unit comprises a hot stove or a pebble heater.

8. The method according to claim 7, wherein said recovered top gas is heated to a temperature of at least 900° C., preferably to a temperature between 1100 and 1300° C., preferably about 1250° C., before introduction into said reformer unit.

9. The method according to any of claims 1 to 8, wherein said recovered top gas is further heated upstream of said heating unit by feeding a portion of said recovered top gas through said cooling zone of said vertical reactor, said portion of said recovered top gas being injected into a lower portion of said cooling zone and recovered in an upper portion of said cooling zone, said injected top gas flowing from said lower portion to said upper portion in a counter flow to said burden.

10. The method according to any of claims 1 to 9, wherein said desulfurizing agent is calcium containing desulfurizing agent.

11. The method according to claim 10, wherein said desulfurizing agent is calcium carbonate containing material fed into said recovered top gas upstream of said reformer unit.

12. The method according to claim 10, wherein said desulfurizing agent is calcium oxide containing material fed into said recovered top gas directly in said reformer unit.

13. The method according to any of claims 1 to 12, wherein said desulfurizing agent has grain size of at least 80 microns, preferably at least 100 microns.

14. The method according to claim 1, wherein
a first portion of said recovered top gas is fed to a hot stove or a pebble heater; and
a second portion of said recovered top gas is fed through said cooling zone of said vertical reactor before being fed to said hot stove or pebble heater, said second portion of said recovered top gas being injected into a lower portion of said cooling zone and recovered in an upper portion of said cooling zone, said injected top gas flowing from said lower portion to said upper portion in a counter flow to said burden.

15. An installation for producing direct reduced iron comprising
a vertical reactor having an upper reducing zone and a lower cooling zone and a gas recycling installation for recovering top gas from said vertical reactor,
submitting at least a portion of said top gas to a recycling process and feeding said recycled top gas back into said vertical reactor
characterised in that
said gas recycling installation comprises a heating unit and a reformer unit; and
said gas recycling installation is configured to carry out the method according to any one of claims 1 to 13.
